(19) United States
(12) Patent Application Publication
(10) Pub. No.: US 2008/0186272 A1
(43) Pub. Date: Aug. 7, 2008

(54) Backlit Display and Backlight System Thereof

(75) Inventors: Danding Huang, Hong Kong SAR (CN); Ying Liu, Hong Kong SAR (CN); Shou Lung Chen, Hong Kong SAR (CN); Huajun Peng, Hong Kong SAR (CN); Chen-Jung Tsai, Hong Kong SAR (CN)

Correspondence Address: BUCHANAN, INGERSOLL & ROONEY PC, POST OFFICE BOX 1404, ALEXANDRIA, VA, 22313-1404, US

(73) Assignee: Hong kong Applied Science and Technology Research Institute Co., ltd., Hong Kong SAR (CN)

(21) Appl. No.: 11/693,643

(22) Filed: Mar. 29, 2007

(30) Foreign Application Priority Data
Feb. 2, 2007 (HK) 07101318.6

(51) Int. Cl. G09G 3/36

(52) U.S. Cl. 345/102

(57) ABSTRACT

A backlight system for a backlit display, the system comprising a plurality of backlight units corresponding to an adjacent region of a backlit display, each unit having at least one light emission source; and a controller for individually controlling each backlight unit to vary at least one light characteristic of light emission from each backlight unit, wherein the at least one light characteristic is defined by determining at least one predefined parameter of light for each of a plurality of regions of an image to be displayed on a backlit display, the regions of the image corresponding to an adjacent backlight unit.

### FIELD OF THE INVENTION

The present invention relates to a backlit display, more particularly to a display having a dynamically controlled backlight system.

### BACKGROUND OF THE INVENTION

Typically, liquid crystal displays (LCD) and liquid crystal on silicon (LCOS) displays are illuminated by a backlight source as the liquid crystals disposed in the LCD panel do not emit light. Instead, the liquid crystals either pass or impede the passage of light such that images may be displayed. In a conventional design, the backlight is typically a white light having as constant an intensity as possible across the LCD panel to present a highly uniform image on the display.

In recent developments, it has been realized that in order to achieve better image representation on the display, it is desirable to have different backlight when displaying different images. For example, bright backlight can better present vivid sky and buildings; whereas dimmed backlight can better present stars in the space. Therefore, dynamic control of the brightness and/or other characters of the backlight source has become more desirable.

For example, U.S. Pat. No. 6,891,672 has disclosed the dynamic adjustment of each pixel of the backlight system. However, such a design may require a large volume of calculation to process the input image for the purpose of compensating the adjustment in the backlight, which may not be desirable.

### SUMMARY OF THE INVENTION

In a first aspect, the present invention provides a backlight system for a backlit display, the system comprising:

a plurality of backlight units corresponding to an adjacent region of a backlit display, each unit having at least one light emission source; and

a controller for individually controlling each backlight unit to vary at least one light characteristic of light emission from each backlight unit, wherein the at least one light characteristic is defined by determining at least one predefined parameter of light for each of a plurality of regions of an image to be displayed on a backlit display, the regions of the image corresponding to an adjacent backlight unit.

The controller preferably provides an image signal to the display panel, wherein the image signal of each said region is provided responsive to the lighting characteristic of a corresponding backlight unit so as to display an image of at least one predetermined visual characteristic.

The plurality of backlight units may comprise an organic light emitting diode (OLED) wherein the OLED film is divided into a plurality of blocks, each block defining a backlight unit.

Alternatively, the plurality of backlight units may comprise a plurality of organic light emitting diode (OLED) films, one or more light emitting diodes (LEDs), one or more cold cathode fluorescent lamps (CCFL), one or more hot cathode fluorescent lamp (HCFL) or one or more electrodeless fluorescent lamp (EFL).

At least one backlight unit may comprise a combination of two or more light sources selected from the group including organic light emitting diodes, LEDs, CCFLs, HCFLs and EFLs.

The light characteristic of light emission from at least one backlight unit may be selected from the group including brightness, colour, light profile, contrast, light intensity and the like of light emission.

The light characteristic of light emission from at least one backlight unit may be a combination of at least two characteristics selected from the group including brightness, colour, light profile, contrast, light intensity and the like of light emission.

A plurality of optical insulators may be further located between the backlight units or located so as to define the backlight units, the optical insulator minimizing, reducing or preventing interference of light emission between adjacent backlight units. Each insulator may include at least one substantially reflective surface between adjacent backlight units.

Light guide plates may be provided having at least one reflective or totally internal reflective side surface so as to reduce or prevent interference between adjacent backlight units.

Preferably, the characteristics of light emission from each backlight unit is substantially uniform or of a predetermined distribution characteristic.

Preferably the controller individually controls the brightness of the light emission of each backlight unit.

In another aspect, the present invention provides a display system comprising:

an image display panel;

a plurality of backlight units corresponding to an adjacent region of the image display panel and each unit having at least one light emission source; and

a controller for individually varying at least one light characteristic of light emission from each backlight unit and for providing an image signal to the image display panel,

wherein the at least one light characteristic is defined by determining at least one predefined parameter of light for each of a plurality of regions of an image to be displayed on a display panel, each region of the image corresponding to an adjacent backlight unit; and

the imagine signal of each said region is provided responsive to the lighting characteristic of a corresponding backlight unit so as to display an image of at least one predetermined visual characteristic.

The image display panel is preferably a liquid crystal display (LCD).

The plurality of backlight units may comprise an organic light emitting diode (OLED) wherein the OLED film is divided into a plurality of blocks, each block defining a backlight unit.

Alternatively, the plurality of backlight units may comprise a plurality of organic light emitting diode (OLED) films.

Each backlight unit may comprise a plurality of light emitting diodes (LEDs), one or more cold cathode fluorescent lamps (CCFL), one or more hot cathode fluorescent lamp (HCFL) or one or more electrodeless fluorescent lamp (EFL).

At least one backlight unit may comprise a combination of two or more light sources selected from the group including organic light emitting diodes, LEDs, CCFLs, HCFLs and EFLs.

The light characteristic of light emission from at least one backlight unit may be selected from the group including brightness, colour, light profile, contrast, light intensity and the like of light emission.

The light characteristic of light emission from at least one backlight unit may be a combination of at least two characteristics selected from the group including brightness, colour, light profile, contrast, light intensity and the like of light emission.

A plurality of optical insulators may be located between the backlight units or located so as to define the backlight units, the optical insulator minimizing, reducing or preventing interference of light emission between adjacent backlight units. Each insulator may include at least one substantially reflective surface between adjacent backlight units.

The light guide plates may be provided having at least one reflective or totally internal reflective side surface so as to reduce or prevent interference between adjacent backlight units.

The characteristics of light emission from each backlight unit may be substantially uniform or of a predetermined distribution characteristic.

Preferably the controller individually controls the brightness of the light emission of each backlight unit.

In a further aspect, the present invention provides a method of displaying an image on a backlit display, the method comprising the steps of:

determining at least one predefined parameter of light for each of a plurality of regions of an image to be displayed on a backlit display;

providing at least one light characteristic by a plurality backlight units corresponding to each respective region of said plurality of regions responsive to said predefined parameter; and

providing an image signal to said display, wherein the imagine signal of each said region of the display is provided responsive to the lighting characteristic of a corresponding backlight unit so as to display an image of at least one predetermined visual characteristic.

Preferably, the predefined parameter is selected from the group including average value, peak value, dimming or intensity value or the like.

The light characteristic provided by the backlight units may be selected from the group including brightness, colour or combinations thereof.

### BRIEF DESCRIPTION OF THE DRAWINGS

Preferred embodiments of the present invention will be explained in further detail below by way of examples and with reference to the accompanying drawings, in which:—

The invention now will be described, by way of example only, and with reference to the accompanying drawings in which:

FIG. 1 shows a cross sectional view illustrating an exemplary LCD in which a backlight system according to the present invention can be used;

FIG. 2 shows a perspective view illustrating a first embodiment of a backlight system according to the present invention;

FIG. 3 shows a flow chart illustrating an exemplary process of processing the input video signal according to the present invention;

FIG. 4 shows a simplified diagram illustrating an exemplary circuitry of processing the input video signal according to the present invention;

FIG. 5 shows a perspective view illustrating a second embodiment of a backlight system according to the present invention;

FIG. 6 shows a perspective view illustrating a third embodiment of a backlight system according to the present invention; and

FIG. 7 shows a perspective view illustrating a fourth embodiment of a backlight system according to the present invention.

### DETAILED DESCRIPTION OF THE PREFERRED EMBODIMENTS

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

The following description refers to exemplary embodiments of a backlit display and its backlight system of the present invention. Reference is made in the description to the accompanying drawings whereby the light emitting diode is illustrated in the exemplary embodiments. Similar components between the drawings are identified by the same reference numerals.

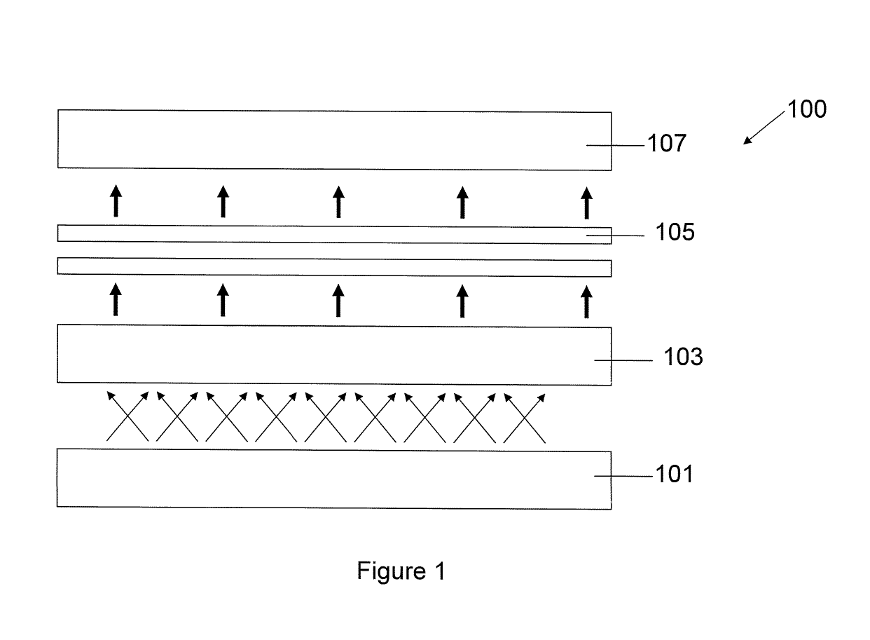

FIG. 1 illustrates an exemplary LCD 100 in which exemplary backlight systems embodiments of the present invention can be used. The LCD 100 includes a backlight system 101 emitting lights. The lights pass though a diffuser 103 such that it the lights become substantially uniform and further through optical films 105 towards an LCD panel 107 as an ordinarily skilled person in the art could understand.

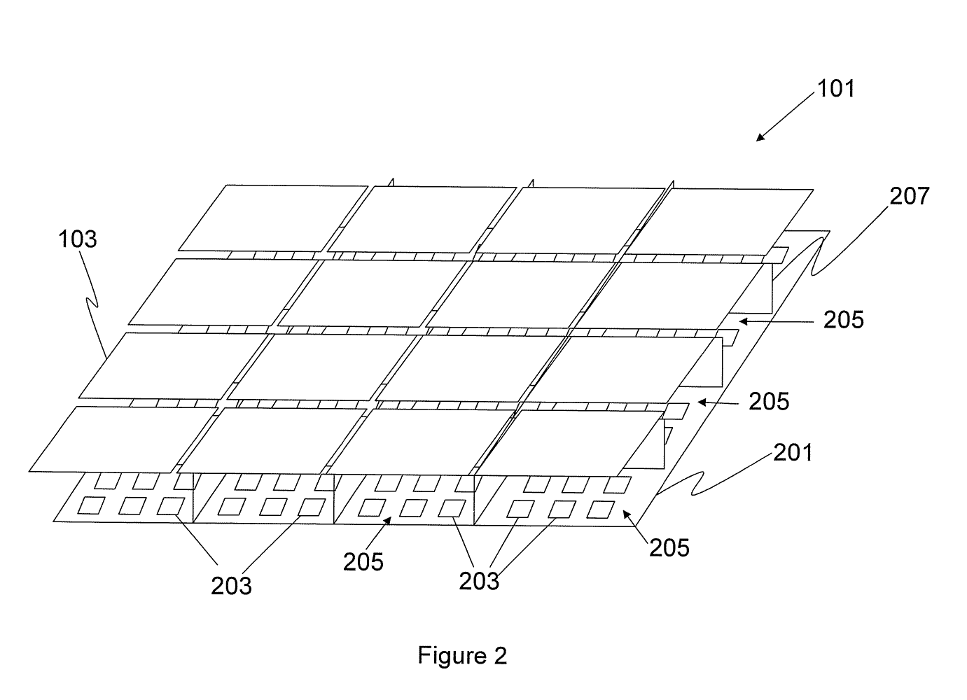

As shown in FIG. 2, an exemplary embodiment of a backlight system 101 includes a backlight board 201 with a plurality of light emitting diodes (LED) 203 thereon, which LEDs 203 are grouped into a plurality of blocks 205. Each block 205 corresponds to a region of the LCD panel (not shown in FIG. 2) and illuminates its corresponding region only, which will be discussed in further detail.

The backlight system also includes a controller, although not shown in the figures, for individually adjusting at least one light characteristic, such as the brightness and/or the colour, of the light emission of each block, responsive to the input video or image signal to be displayed on the LCD panel at a region corresponding to an adjacent backlight unit or region, such that the light emission of each unit 205 is substantially uniform. As will be appreciated by those skilled in the art, the light emission is not limited to substantial uniform light emission but may be a predetermined pattern or variation of emission based upon the image at an adjacent region of the display.

The backlight system 101 further includes a plurality of grid 207 or walls between adjacent blocks and extending from the backlight board 201 to the diffuser 103 such that interference between the light emissions of adjacent blocks can be avoided. Thereby, each block 205 substantially only illuminates its corresponding region on the LCD panel.

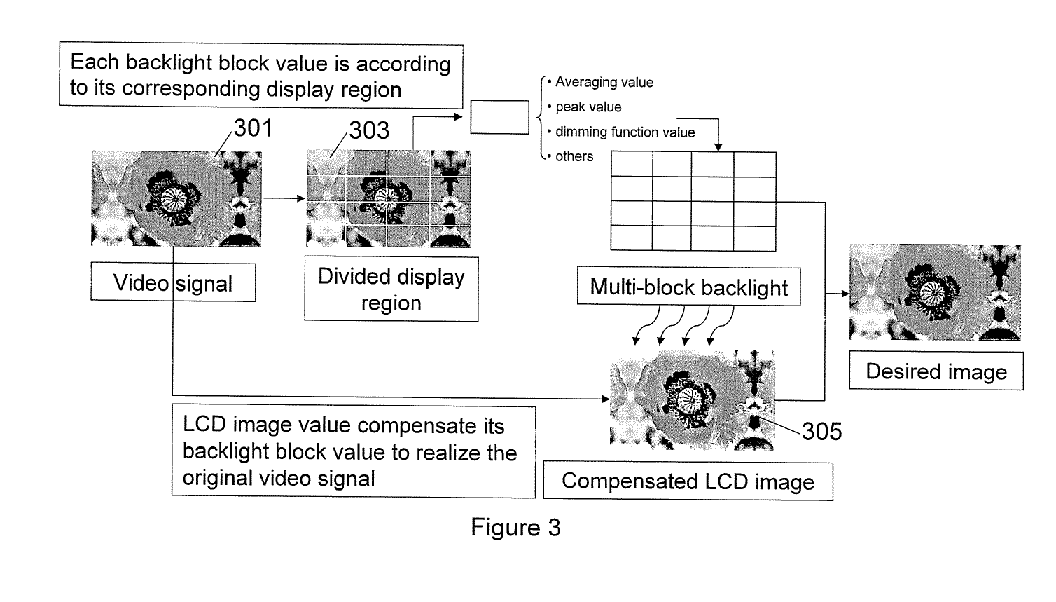

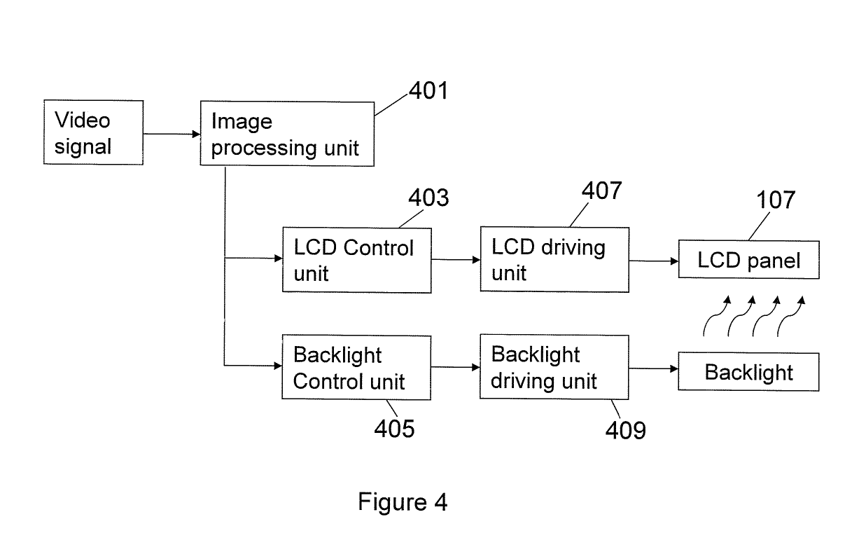

Referring to FIGS. 3 and 4, an exemplary process of processing the input video signal is described.

Firstly, the input video signal 301 is passed on to both an LCD controller 403 and a backlight controller 405 through an image processing unit 401 which divides the input video signal 301 into a plurality of blocks indicated by arrow 303 in accordance with the divided regions of the LCD panel.

The backlight controller 405 determines at least one predefined parameter of light, such as brightness and/or colour for the light emission, based upon an image to be displayed on the display, and a signal indicative of such parameter is provided to each backlight block of each block in the corresponding region of the LCD panel. A modified or balanced video signal is then determined and provided to the display panel. This modified or balanced video signal is determined such that when in combination with the light emitted from an adjacent backlight block a desired or required visual image is provided.

As will be appreciated by those skilled in the art, numerous predefined parameters may be incorporated for determining a lighting characteristic, these parameters including average value, peak value, dimming or intensity value or the like, such as by averaging the values of the input video/image signal within the corresponding region, by selecting a maximum value of the input video/image signal within the corresponding region, and etc.

After determination of the brightness and/or colour for the light emission of each block of LEDs, the LCD controller 403 calculates a compensated, modified or balanced LCD image 305 dependent upon the brightness and/or colour of the light emission of each block of LEDs of the backlight system as will be understood by a person skilled in the art, as discussed above. The compensated LCD image 305 will be passed onto the LCD driving unit for display on the LCD panel 107. As the LCD panel 107 is illuminated by the backlight system, a combination of the backlight and the compensated LCD image results in a representation of the input (desired) video/image in the user's eye.

It will also be appreciated by those skilled in the art that the image displayed by the display unit need not be in accordance with the original image to be displayed, and that predefined parameters in the controller and the manner controller “balances” the backlight light characteristics and the image signal may be so as to provide a particular effect or requirement.

A skilled person will appreciate that by dividing the backlight system into a plurality of blocks, each being individually controlled, the calculation of the compensated LCD image can be simplified as only backlight from limited number of blocks of light emitting sources is considered. Thereby image processing can be accelerated, which can ease the real-time display of the input video/images. In addition, as each block of backlight can be turned on/off or dimmed individually, power consumption can be optimised or minimised.

A skilled person will further appreciated that the calculation of the compensated LCD image can be further simplified due to the minimized interference between the light emission of adjacent blocks of LEDs in the backlight system. As each region on the LCD panel is only illuminated by its corresponding block of LEDs, when calculating the compensated LCD image for each region, the LCD controller 403 only needs to take into consideration of the light emission of the corresponding block of LEDs, without the need of considering the light emission from other (for example adjacent) blocks. This will significantly reduce the volume of calculation in the image processing.

In addition, the brightness of each LED within one block can be adjusted either independently or uniformly in the exemplary embodiment. In the exemplary embodiment, due to the mixture of light by the diffuser, the backlight emitted towards the display is substantially uniform, which will further simplify the calculation of the compensated display image.

However, a skilled person in the art will appreciate that the present invention may also be applicable to a scenario in which the backlight from the backlight system is non-uniform. In such a scenario, the calculation of the compensated display image for each region may need to take into consideration of the possible effect brought by the non-uniformity of the backlight from the corresponding block of LEDs.

A skilled person in the art will further appreciate that the present invention may be applicable to a scenario in which there exists interference between the light emission from adjacent blocks of LEDs. Calculation of the compensated display image for each region of the display may be based upon the backlight from limited number of blocks of LEDs, for example, the corresponding block of LEDs of each region of the display alone or in combination with a limited number of LEDs of adjacent blocks. In this way, the calculation of the compensated display image can still be simplified.

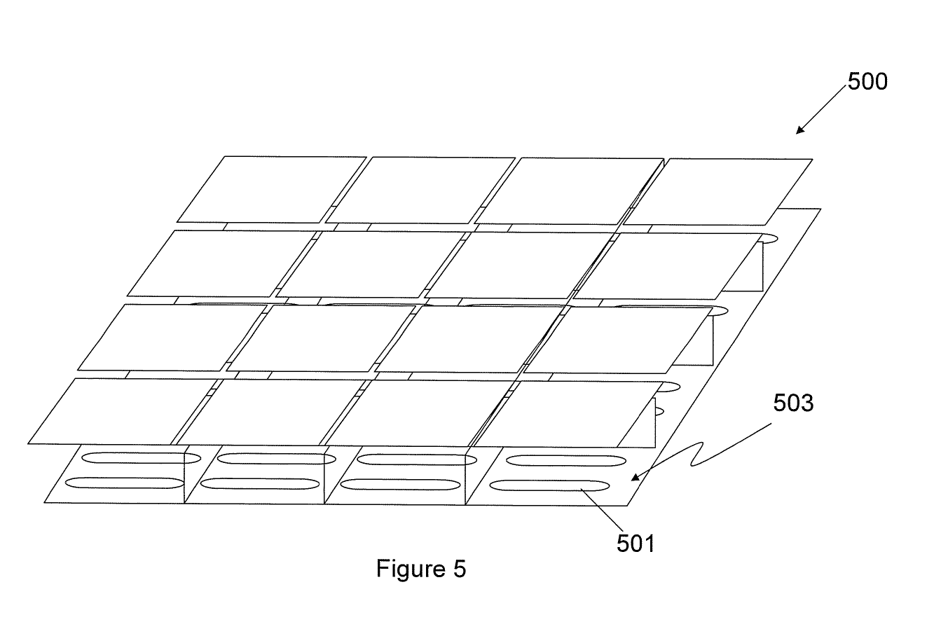

FIG. 5 illustrates a second embodiment of a backlight system 500, similar to the embodiment of FIG. 2, but with a plurality of cold cathode fluorescent lamps 501 (CCFL) on a CCFL backlight board 503 and grouped into a plurality of groups, instead of the LEDs.

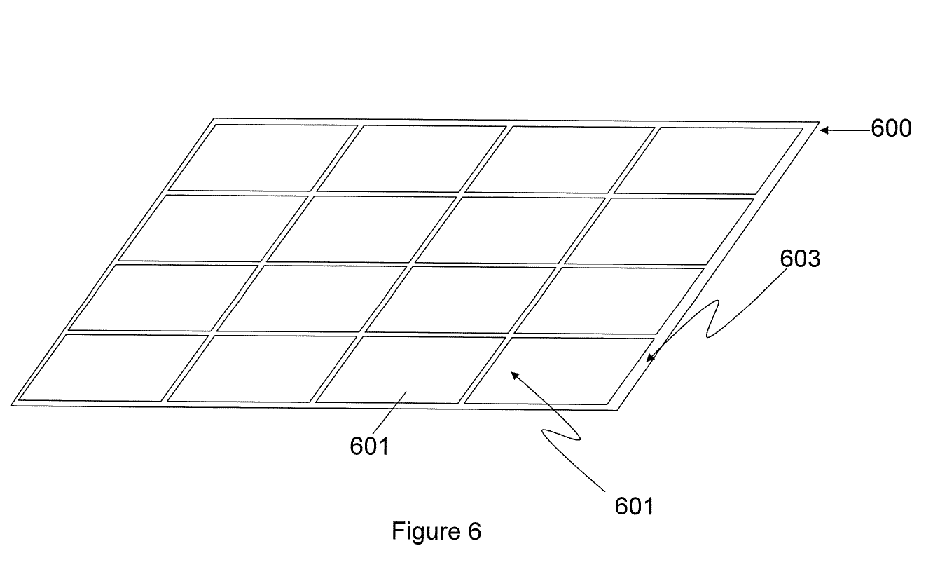

FIG. 6 illustrates a third embodiment of a backlight system 600, having a plurality of organic LED (OLED) films 601 on a backlight board 603, each OLED 601 functioning similar to a block of LEDs of the embodiment of FIG. 2. The backlight system 600 is in close proximity to the display (not shown in FIG. 6) to reduce or minimize interference between the light emission of different OCLE films 601.

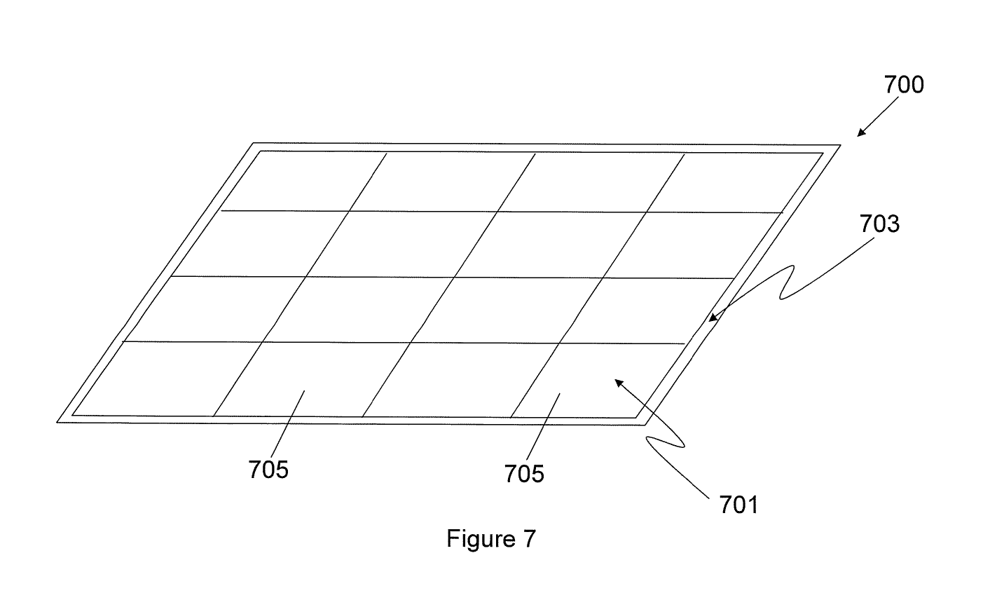

FIG. 7 illustrates a fourth embodiment of a backlight system 700, similar to the embodiment of FIG. 6, but having only one OLED film 701 on the backlight board 703. The OLED film 701 is virtually divided into multiple blocks 705, and each block is driven and adjusted individually.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

1. A backlight system for a backlit display, the system comprising:
a plurality of backlight units corresponding to an adjacent region of a backlit display, each unit having at least one light emission source; and
a controller for individually controlling each backlight unit to vary at least one light characteristic of light emission from each backlight unit, wherein the at least one light characteristic is defined by determining at least one predefined parameter of light for each of a plurality of regions of an image to be displayed on a backlit display, the regions of the image corresponding to an adjacent backlight unit.

2. A backlight system according to claim 1, wherein the controller provides an image signal to the display panel and wherein the image signal of each said region is provided responsive to the lighting characteristic of a corresponding backlight unit so as to display an image of at least one predetermined visual characteristic.

3. A backlight system according to claim 1, wherein the plurality of backlight units comprises an organic light emitting diode (OLED) wherein the OLED film is divided into a plurality of blocks, each block defining a backlight unit.

4. A backlight system according to claim 1, wherein the plurality of backlight units comprises a plurality of organic light emitting diode (OLED) films.

5. A backlight system according to claim 1, wherein each backlight unit comprises one or more light emitting diodes (LEDs).

6. A backlight system according to claim 1, wherein each backlight unit comprises one or more cold cathode fluorescent lamps (CCFL).

7. A backlight system according to claim 1, wherein each backlight unit comprises one or more hot cathode fluorescent lamp (HCFL).

8. A backlight system according to claim 1, wherein each backlight unit comprises one or more electrodeless fluorescent lamp (EFL).

9. A backlight system according to claim 1, wherein at least one backlight unit comprises a combination of two or more light sources selected from the group including organic light emitting diodes, LEDs, CCFLs, HCFLs and EFLs.

10. A backlight system according to claim 1, wherein the light characteristic of light emission from at least one backlight unit is selected from the group including brightness, colour, light profile, contrast, light intensity and the like of light emission.

11. A backlight system according to claim 1, wherein the light characteristic of light emission from at least one backlight unit is a combination of at least two characteristics selected from the group including brightness, colour, light profile, contrast, light intensity and the like of light emission.

12. A backlight system according to claim 1, further comprising a plurality of optical insulators located between the backlight units or located so as to define the backlight units, the optical insulator minimizing, reducing or preventing interference of light emission between adjacent backlight units.

13. A backlight system according to claim 12, wherein each insulator includes at least one substantially reflective surface between adjacent backlight units.

14. A backlight system according to claim 1, wherein light guide plates are provided having at least one reflective or totally internal reflective side surface so as to reduce or prevent interference between adjacent backlight units.

15. The backlight system according to claim 1, wherein the characteristics of light emission from each backlight unit is substantially uniform or of a predetermined distribution characteristic.

16. The backlight system according to claim 1, wherein the controller individually controls the brightness of the light emission of each backlight unit.

17. A display system comprising:
an image display panel;
a plurality of backlight units corresponding to an adjacent region of the image display panel and each unit having at least one light emission source; and
a controller for individually varying at least one light characteristic of light emission from each backlight unit and for providing an image signal to the image display panel,
wherein the at least one light characteristic is defined by determining at least one predefined parameter of light for each of a plurality of regions of an image to be displayed on a display panel, each region of the image corresponding to an adjacent backlight unit; and
the imagine signal of each said region is provided responsive to the lighting characteristic of a corresponding backlight unit so as to display an image of at least one predetermined visual characteristic.

18. A display system according to claim 17, wherein the image display panel is a liquid crystal display (LCD).

19. A display system according to claim 17, wherein the plurality of backlight units comprises an organic light emitting diode (OLED) wherein the OLED film is divided into a plurality of blocks, each block defining a backlight unit.

20. A display system according to claim 17, wherein the plurality of backlight units comprises a plurality of organic light emitting diode (OLED) films.

21. A display system according to claim 17, wherein each backlight unit comprises one or more light emitting diodes (LEDs).

22. A display system according to claim 17, wherein each backlight unit comprises one or more cold cathode fluorescent lamps (CCFL).

23. A display system according to claim 17, wherein each backlight unit comprises one or more hot cathode fluorescent lamp (HCFL).

24. A display system according to claim 17, wherein each backlight unit comprises one or more electrodeless fluorescent lamp (EFL).

25. A display system according to claim 17, wherein at least one backlight unit comprises a combination of two or more light sources selected from the group including organic light emitting diodes, LEDs, CCFLs, HCFLs and EFLs.

26. A display system according to claim 17, wherein the light characteristic of light emission from at least one backlight unit is selected from the group including brightness, colour, light profile, contrast, light intensity and the like of light emission.

27. A display system according to claim 17, wherein the light characteristic of light emission from at least one backlight unit is a combination of at least two characteristics selected from the group including brightness, colour, light profile, contrast, light intensity and the like of light emission.

28. A display system according to claim 17, further comprising a plurality of optical insulators located between the backlight units or located so as to define the backlight units, the optical insulator minimizing, reducing or preventing interference of light emission between adjacent backlight units.

29. A display system according to claim 28, wherein each insulator includes at least one substantially reflective surface between adjacent backlight units.

30. A display system according to claim 17, wherein light guide plates are provided having at least one reflective or totally internal reflective side surface so as to reduce or prevent interference between adjacent backlight units.

31. The display system according to claim 17, wherein the characteristics of light emission from each backlight unit is substantially uniform or of a predetermined distribution characteristic.

32. The display system according to claim 17, wherein the controller individually controls the brightness of the light emission of each backlight unit.

33. A method of displaying an image on a backlit display, the method comprising the steps of:
determining at least one predefined parameter of light for each of a plurality of regions of an image to be displayed on a backlit display;
providing at least one light characteristic by a plurality backlight units corresponding to each respective region of said plurality of regions responsive to said predefined parameter; and
providing an image signal to said display, wherein the imagine signal of each said region of the display is provided responsive to the lighting characteristic of a corresponding backlight unit so as to display an image of at least one predetermined visual characteristic.

34. A method according to claim 33 wherein the predefined parameter is selected from the group including average value, peak value, dimming or intensity value or the like.

35. A method according to claim 33, wherein the light characteristic provided by the backlight units is selected from the group including brightness, colour or combinations thereof.

36. A method according to claim 34, wherein the light characteristic provided by the backlight units is selected from the group including brightness, colour or combinations thereof.
